(19) United States
(12) Patent Application Publication
(10) Pub. No.: US 2006/0142055 A1
(43) Pub. Date: Jun. 29, 2006

(54) Printed circuit board structure for mobile terminal

(75) Inventors: Shi-Yun Cho, Seoul (KR); Young-Min Lee, Yongin-si (KR); Jea-Hyuck Lee, Anyang-si (KR); Shin-Hee Cho, Suwon-si (KR); Kyung-Wan Park, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/114,432

(22) Filed: Apr. 26, 2005

(30) Foreign Application Priority Data
Dec. 27, 2004 (KR) 2004-112960

(51) Int. Cl. H04B 1/28; H04M 1/00

(52) U.S. Cl. 455/556.1; 455/333

(57) ABSTRACT

A printed circuit board structure for a mobile terminal including a main printed circuit board including elements required for functions of the mobile terminal and mounted on an upper surface of the main printed circuit board, and an auxiliary printed circuit board laminated on the main printed circuit board including at least one element further required for the functions of the mobile terminal and mounted on an upper surface of the auxiliary printed circuit board.

### CLAIM OF PRIORITY

This application claims priority to an application entitled “PRINTED CIRCUIT BOARD STRUCTURE FOR MOBILE TERMINAL,” filed in the Korean Intellectual Property Office on Dec. 27, 2004 and assigned Serial No. 2004-112960, the contents of which are hereby incorporated by reference.

### BACKGROUND OF THE INVENTION

1. Field of the Invention

The present invention relates to a printed circuit board (PCB) system for a mobile terminal, and more particularly to a PCB structure used in a mobile terminal in which an auxiliary PCB configured to mount various elements thereon is laminated on a main PCB.

2. Description of the Related Art

Recently-developed mobile terminals are capable of providing multiple functions and have been further downsized. For example, mobile terminals have been advanced from a single band-type to a dual or triple band-type to enable complex functions, such as electronic note, diary, telephone dictionary, and camera functions. However, the availability of multiple complex features requires printed circuit boards to accommodate the increased number of elements/components on its limited surface.

Techniques for mounting elements and downsizing a PCB ranges from a pin type design to a ball grid array (BGA) design, a chip scale package (CSP) design, and a land grid array (LGA) design. Using these designs, however, it is difficult to adequately increase the element mounting density that is needed to mount all elements required for complex functions while downsizing its shape. Furthermore, in order to mount a large number of elements on a PCB, it is necessary to also form a large number of openings for wiring connection through the PCB. As a result, the costs and time associated with manufacturing PCBs are increased.

FIGS. 1 and 2 shows a conventional PCB structure used in a mobile terminal. As shown, the PCB structure includes a PCB 1 having a ground surface 1a. A regulator 2, a decoupling capacitor 3, and a radio frequency integrated circuit (RF IC) 4 are mounted on the PCB 1. Lines 5 extend through the PCB 1 to connect the elements mounted on the PCB 1. For the same purpose, via holes 6 are also formed through the PCB 1. To drive the RF IC 4 at high speed and to supply power to the mobile terminal, the regulator 2 generates DC power and supplies the DC power to a power terminal of the RF IC 4.

In order to a steady power supply to the RF IC 4, the decoupling capacitor 3, which is a passive element, is provided near the RF IC 4. More specifically, ground and supply voltages are applied to the RF IC 4 via a wiring formed on a certain layer in the PCB 1 and extends to a region near the RF IC 4. To this end, a ground layer and a supply voltage layer are formed at the PCB.

In order to supply a steady power while reducing the generation of noise, it is necessary to provide a ground surface with a larger area. When the ground surface is small, elements on the ground surface of the PCB may interfere with each other which may cause noise to be generated.

When the above PCB structure is applied to a mobile terminal having multiple functions, it is necessary to mount more RF IC elements on the PCB, thus increasing the number of lines and via holes through the PCB. For this reason, the regulator adapted to supply power to the RF IC must have a reduced mounting area or must be divided into several separate parts which in turn makes it difficult to stably supply the power. Moreover, the ground surface area between adjacent elements is greatly reduced, thus noise may be generated. Such power noise causes the power supply to be unstable. Further, an interference between RF signals and thermal noise may increase. As a result, the power supply becomes more unstable, thereby causing a degradation in the performance of the RF IC.

### SUMMARY OF THE INVENTION

The present invention has been made to overcome the above-mentioned problems and provide additional advantages, by providing a PCB structure for a mobile terminal in which an auxiliary PCB configured to mount various elements or components thereon is laminated on a main PCB in order to minimize interference between elements caused by a limited ground surface area, thereby reducing the generation of noise.

One aspect of the invention is to provide a PCB structure for a mobile terminal in which an auxiliary PCB configured to mount various elements thereon is laminated on a main PCB, so that it is possible to provide a wide and undamaged ground surface, thus achieving a stable power supply.

Another aspect of the invention is to provide a PCB structure for a mobile terminal in which an auxiliary PCB made of a soft material is laminated on a main PCB, so that it is possible to reduce the area of the auxiliary PCB for an appropriate use thereof using a cutting process, and to apply the auxiliary PCB to various shapes of main PCBs.

Yet another aspect of the invention is to provide a PCB structure for a mobile terminal in which an auxiliary PCB is laminated on a main PCB, so that it is possible to mount elements on dual layers to achieve high-density mounting of elements, while reducing the overall PCB size. As a result, the mobile terminal can be further miniaturized.

### BRIEF DESCRIPTION OF THE DRAWINGS

The above advantages of the present invention will become more apparent by describing in detail preferred embodiments thereof with reference to the attached drawings in which:

FIG. 1 is a schematic sectional view illustrating a conventional PCB structure;

FIG. 2 is a schematic plan view illustrating the conventional PCB structure;

FIG. 3 is a schematic sectional view illustrating a PCB structure according to an exemplary embodiment of the present invention; and

FIG. 4 is a schematic plan view illustrating the PCB structure according to the exemplary embodiment of the present invention.

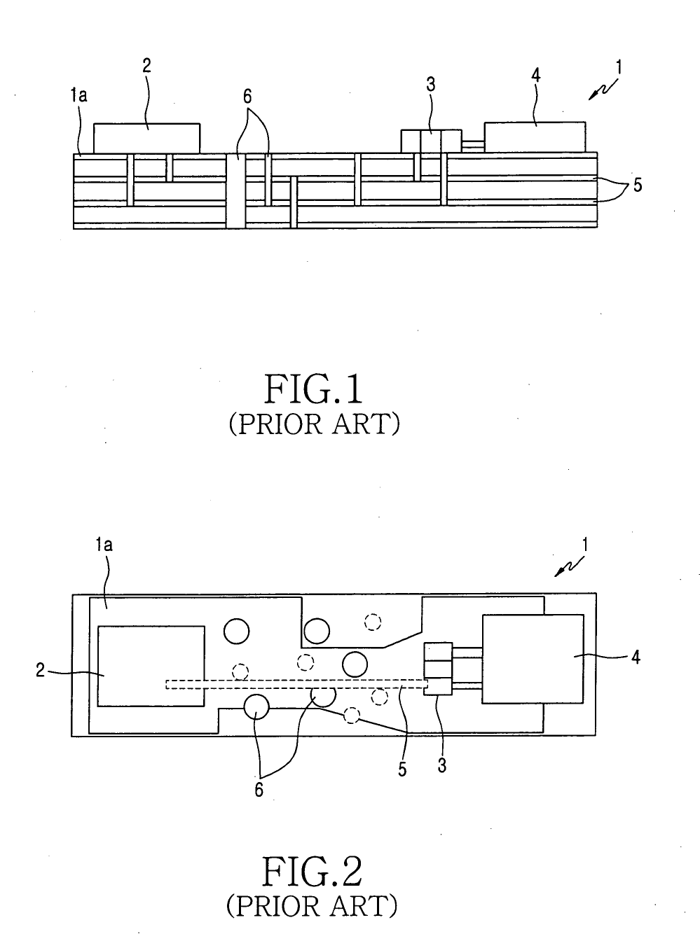

### DETAILED DESCRIPTION

Now, embodiments of the present invention will be described in detail with reference to the annexed drawings. For the purposes of clarity and simplicity, a detailed description of known functions and configurations incorporated herein will be omitted as it may make the subject matter of the present invention unclear.

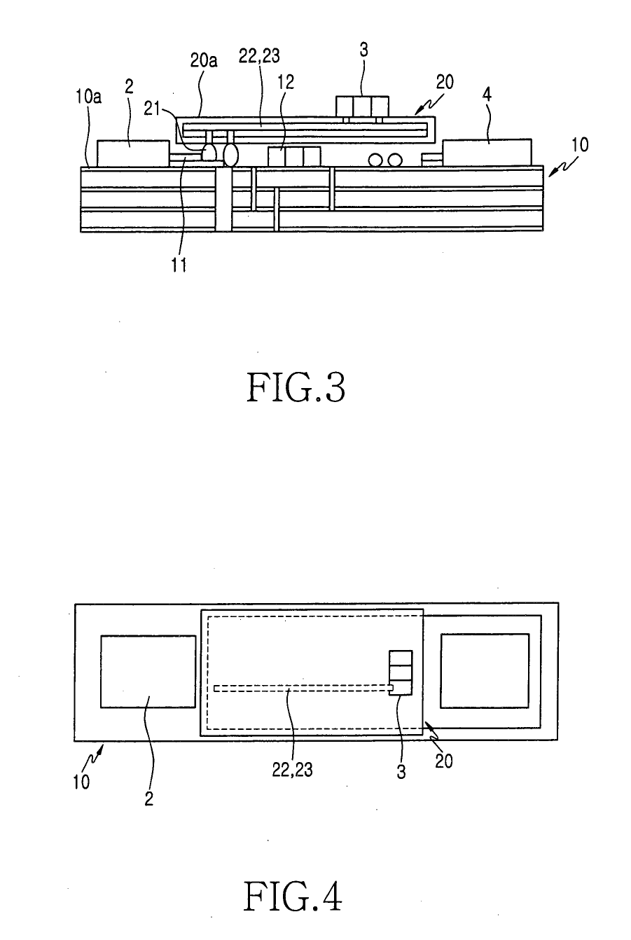

Referring to FIGS. 3 and 4, a PCB structure according to an embodiment of the present invention includes a main PCB 10 having a main mounting surface 10a for mounting various elements, such as elements 2, 4, and 12, and a mounting pattern 11. The PCB structure also includes an auxiliary PCB 20 laminated on the main PCB 10 and coupled to the mounting pattern 1. The auxiliary PCB 20 is provided, at an upper surface thereof, with an auxiliary mounting surface 20a for mounting various elements, such as the element 3. The element 3 mounted on the auxiliary mounting surface 20a may be used to supply power. The mounting surfaces 10a and 20a server as ground for the elements mounted thereof.

The auxiliary PCB 20 is substantially smaller than the main PCB 10. As such, the auxiliary PCB 20 is mounted inside the main PCB 10. The auxiliary PCB 20 is also provided with a land pattern 21 to be coupled with the mounting pattern 11 of the main PCB 10.

The auxiliary PCB 20 may be made of a soft material, such as polyimide or other soft substrate used for a flexible PCB, so that the auxiliary PCB 20 can be cut to be fitted inside the main PCB 10 or can be cut for other appropriate use thereof. The auxiliary PCB 20 is also formed with a power supply wring 22 and a connecting wiring 23 to transmit an RF signal to the main PCB 10.

Hereinafter, manufacture of the above-described PCB structure according to the illustrated embodiment of the present invention will be described in detail.

As shown in FIG. 3, a regulator 2, which is adapted to supply power, is mounted on the main PCB 10. A passive element 12 for supplying power is also mounted on the main PCB 10 near the regulator 2. An RF IC 4 for supplying power is mounted on the main PCB 10 near the passive element 12.

The regulator 2 is coupled with a mounting pattern 11 that is formed on the main PCB 10. In this state, the auxiliary PCB 20 is mounted on the main PCB 10 in a laminated state.

Upon mounting the auxiliary PCB 20 on the main PCB 10, the land pattern 21 provided at the auxiliary PCB 20 is coupled to the mounting pattern 11 of the main PCB 10.

Thereafter, elements for supplying power may be mounted on the auxiliary PCB 20. For example, a decoupling capacitor 3 for supplying power may be mounted on the auxiliary PCB 20.

If necessary, the auxiliary PCB 20 may be mounted on the main PCB 10 after being cut into a desired size, so that the auxiliary PCB 20 is arranged inside the main PCB 10. Note that the cutting of the auxiliary PCB 20 can be easily achieved as the auxiliary PCB 20 is made of a soft material.

Thereafter, the auxiliary PCB 20 may be also provided with a wiring 22 for supplying power and a connecting wiring 23 to transmit an RF signal to the main PCB 10.

As described above, a laminated PCB structure is obtained in which the auxiliary PCB is laminated on the main PCB, so that elements/components that are conventionally mounted on the main PCB can be also mounted on the auxiliary PCB. As a result, the size of mobile terminals utilizing the PCB structure according to the teachings of the present invention can be reduced. Further, it is possible to minimize interference between elements caused by the limited ground surface area, thus reducing generation of noise.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A printed circuit board structure for a mobile terminal, comprising:
a main printed circuit board having a mounting pattern for mounting a plurality of components on an upper surface of the main printed circuit board; and
an auxiliary printed circuit board laminated on the main printed circuit board and coupled to the mounting pattern for mounting at least one other component used for the function of the mobile terminal on an upper surface thereof.

2. The printed circuit board structure according to claim 1, wherein the upper surface of the main printed circuit board has a main mounting surface for mounting the plurality of components required for the functions of the mobile terminal.

3. The printed circuit board structure according to claim 1, wherein the auxiliary printed circuit board is substantially smaller than the main printed circuit board.

4. The printed circuit board structure according to claim 1, wherein the auxiliary printed circuit board includes a land pattern to be coupled with the mounting pattern of the main printed circuit board.

5. The printed circuit board structure according to claim 1, wherein the auxiliary printed circuit board is made of a soft material.

6. The printed circuit board structure according to claim 1, wherein the auxiliary printed circuit board includes a wiring for supplying power and a connecting wiring for transmitting an RF signal.

7. The printed circuit board structure according to claim 1, wherein the upper surface of the auxiliary printed circuit board has an auxiliary mounting surface to mount the at least one other component used for the function of the mobile terminal.

8. A printed circuit board structure for a mobile terminal, comprising:
a main printed circuit board having a mounting pattern and including elements required for functions of the mobile terminal on an upper surface thereof; and
a printed circuit board laminated on the main printed circuit board and coupled to the mounting pattern for mounting other elements required for functions of the mobile terminal on an upper surface thereof.

9. A method for generating a printed circuit board having a first board and a second board for a mobile terminal, the method comprising the operations of:
mounting a first plurality of components on the first board;
laminating the first board on the second board; and
mounting a second plurality of components on the second board.

10. The method according to claim 9, further comprising providing a wiring to supply power and transmit an RF signal to the first board.

11. The method according to claim 9, wherein the second board is substantially smaller than the first board.

12. The method according to claim 9, wherein the second board is made of a soft material.
